(19) United States
(12) Patent Application Publication
(10) Pub. No.: US 2017/0064971 A1
(43) Pub. Date: Mar. 9, 2017

(54) MULTI-STEP PROCESS FOR PRODUCING INTERMEDIATE MOISTURE FOODS, AND ASSOCIATED SYSTEMS AND METHODS

(71) Applicant: Oberto Sausage Company, Kent, WA (US)

(72) Inventors: Richard Meyer, Kent, WA (US); Dina Price, Kent, WA (US)

(21) Appl. No.: 15/232,653

(22) Filed: Aug. 9, 2016

Related U.S. Application Data
(63) Continuation of application No. 13/647,282, filed on Oct. 8, 2012, now abandoned.
(60) Provisional application No. 61/545,077, filed on Oct. 7, 2011.

(51) Int. Cl. A23B 4/03; A23B 4/005

(52) U.S. Cl. CPC A23B 4/031; A23B 4/0053; A23V 2002/00

(57) ABSTRACT

Food processing methods and associated apparatuses are disclosed herein. In one embodiment, a food processing method includes heating a meat product in an oven to a pasteurizing temperature of the meat product followed by drying the meat product at the oven temperature that is below the maximum oven temperature of the processing cycle. In another embodiment, the method includes heating a meat product in a continuous belt grill, followed by drying the meat product in a temperature/relative humidity controlled oven. By breaking the food processing method into at least two phases, the method can result in a shorter processing time with better control of the process end points.

### CROSS-REFERENCE TO RELATED APPLICATION(S)

This application is a continuation of U.S. patent application Ser. No. 13/647,282, filed on Oct. 8, 2012, and entitled “MULTI-STEP PROCESS FOR PRODUCING INTERMEDIATE MOISTURE FOODS, AND ASSOCIATED SYSTEMS AND METHODS,” which claims the benefit of U.S. Provisional Patent Application Ser. No. 61/545,077, filed on Oct. 7, 2011, and entitled “METHODS AND SYSTEMS FOR PRODUCING INTERMEDIATE MOISTURE FOODS.” The foregoing applications are incorporated herein by reference in their entireties.

### TECHNICAL FIELD

The present technology generally relates to food processing. More particularly, several embodiments of the present technology relate to methods and systems for processing meats.

### BACKGROUND

It has been known in the food processing industry that reducing a moisture protein ratio to or below 0.75, reducing the water activity to or below 0.85, and pasteurizing the food (e.g., at least 160° F. internal temperature for beef) controls growth of bacterial pathogens of concern and comports with the USDA regulations. With vegetables, enzyme inactivation and pasteurization are achieved using a hot water blanching followed by subjecting the vegetables to a hot air process. With fruit, a sulfite treatment is used to inhibit both enzyme and microbe growth prior to the hot air drying.

In the food processing industry, the process of drying meats, fruits and vegetables is traditionally performed using hot air without humidity control. For example, beef jerky is processed using hot air in an oven to heat the food product and to reduce the moisture level of the product. The meat must be heated to an internal temperature of at least 160° F. to pasteurize the meat and remove sufficient moisture to achieve a target water activity level in the food product that inhibits microbial activity. In the traditional meat jerky manufacturing processes, only the temperature in the oven and the time to reach the minimum pasteurizing temperature are controlled. However, the target for the internal food temperature may be reached at a different time and/or be a different temperature than the ideal time and temperature for the target water activity of the food product. Furthermore, conventional processes typically increase the temperature gradually until the internal temperature of the food product reaches the target pasteurizing temperature. Although the conventional processes often stop heating when the maximum process temperature is reached, conventional processes typically have a cool-down period before handling the product (e.g., testing) to avoid exposing workers to the high temperatures of the food product. This is problematic because the food product continues to dry during the cool-down period, which makes it difficult to control the final water activity in the meat. As a result, if the cool-down period or other factors are not correct for a certain batch, the food product can be either too dry to be palatable or too moist to prevent microbial activity in the food product.

### BRIEF DESCRIPTION OF THE DRAWINGS

FIG. 1 is a temperature/water activity chart in accordance with the prior art technology.

FIG. 2 is a flow diagram illustrating the process of drying meats in accordance with an embodiment of the present technology.

FIG. 3 is a schematic illustration of an oven that can be used with the embodiments of the present technology.

FIG. 4A is a temperature/water activity chart in accordance with an embodiment of the present technology.

FIG. 4B is a relative humidity/wet bulb chart in accordance with an embodiment of the present technology shown in FIG. 4A.

FIG. 5 is a schematic illustration of a continuous belt oven that can be used with the embodiments of the present technology.

FIG. 6A is a temperature/water activity chart in accordance with another embodiment of the present technology.

FIG. 6B is a relative humidity/wet bulb chart in accordance with the embodiment of the present technology shown in FIG. 6A.

FIG. 7 is a temperature/water activity chart in accordance with another embodiment of the present technology.

### DETAILED DESCRIPTION

The present technology is generally directed toward food processing methods and associated apparatuses capable of producing dried food products, for example meat jerky. In particular, the present technology reduces processing times by separating a heating phase that rapidly reaches the required minimum pasteurization temperature of the food product and a drying phase that reduces the water activity at or below a target value for a given food product. By separating the process into at least two phases, the combined process time is reduced while the problems associated with conventional technologies are avoided. For example, a shorter heating phase can be achieved without excessive relative humidity that can result in water condensation on the surface of the food product. The drying phase can also be shortened by reducing the drying temperature in conjunction with reducing the relative humidity in the equipment, thus reducing the incidence of high temperature induced case hardening on the surface of the food product. Case hardening is a known process of creating a water impermeable skin on the food product, which, in turn, impedes drying of the product. The lower temperature and humidity of the drying phase also improves the uniformity of the drying. Additionally, having a lower end point temperature for the drying phase is safer and more comfortable for the operators who handle the food product at the end of the processing.

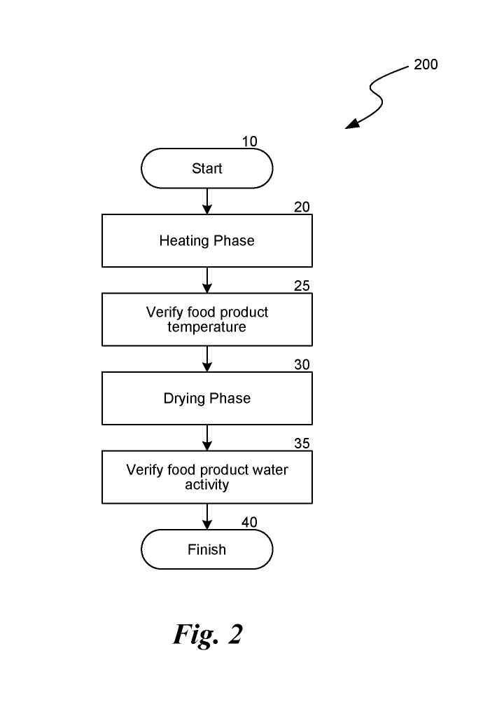

Specific details of certain embodiments of the technology are set forth in the following description and in FIGS. 2-7 to provide a thorough understanding of such embodiments. One skilled in the art, however, will recognize that the technology can be practiced without one or more specific details explained in the following description. Moreover, although the following disclosure sets forth several embodiments of the technology, other embodiments of the technology can have different configurations or different components than those described in this section. As such, it should be understood that the technology may have other embodiments with additional elements or without several of the elements shown and described below with reference to FIGS. 2-7.

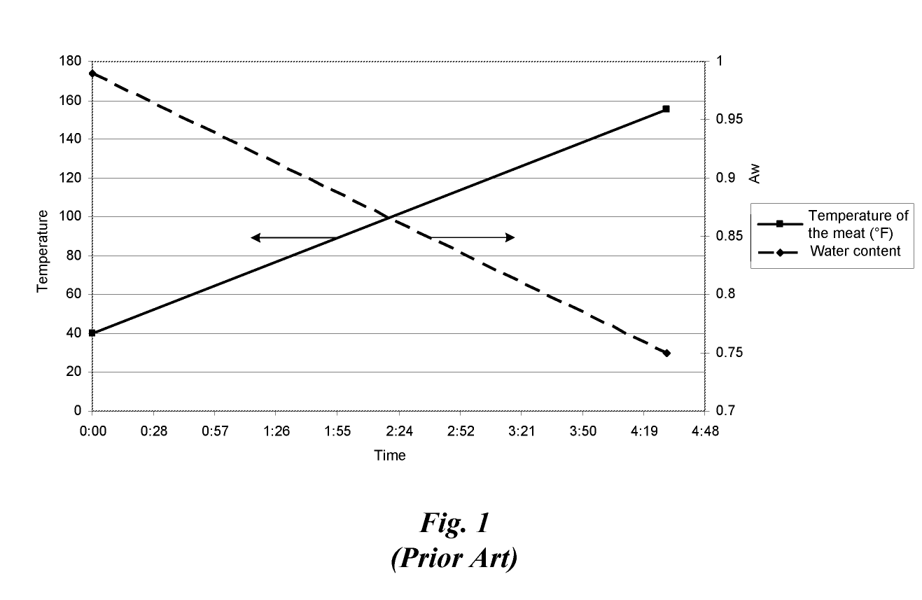

FIG. 1A is a chart illustrating conventional food processing technology for making beef jerky. The horizontal axis of the diagram represents the processing time and the vertical axes of the diagram represent the internal temperature of the product (the left axis) and water activity (the right axis). With the conventional technology, the temperature of the food product increases throughout the process until it reaches the pasteurizing temperature, while simultaneously drying the product, i.e., reducing the water activity of the product. Due to the combined heating and drying phases in the conventional process, the minimum pasteurizing temperature and the maximum allowable water activity may be reached at different times. For example, FIG. 1 illustrates that the maximum allowable water activity of about 0.85 was reached after about two hours and 40 minutes, but the process continued because the target pasteurization temperature of the product had not yet been reached. At the end of the conventional process illustrated in FIG. 1 when the target pasteurization temperature of 160° F. had been reached, the water activity of the product had dropped to about 0.75. Therefore, the conventional process over-dried the food product at the required pasteurization temperature. Furthermore, the pasteurizing temperature at the end of the conventional process is unsafe and/or uncomfortable for handling the food product, and the total processing time of about four hours and 30 minutes limits the throughput of the equipment.

FIG. 2 is a flow chart illustrating an embodiment of the present technology. The food processing method 200 can start (block 10) after other processing steps have occurred, for example, preparing and seasoning the incoming food product. The method further includes heating the food product (block 20) to pasteurize the food product during a heating phase. A person skilled in the art would know many methods of heating the food product including, for example, radiative, convective or conductive heating using electricity, gas, oil or solid fuels, or a combination thereof. As explained below, the temperature, relative humidity and duration of the heating phase can be selected depending on the type and size of the food product because the pasteurization temperature which must be reached in the middle of the food product depends on the size and type of the food product. Although a single heating phase is illustrated in the diagram, several heating phases can also be used.

After or during the heating phase, the temperature of the product may be verified (block 25) to determine whether the pasteurization temperature of the product has been reached. Alternatively, the temperature and duration of the heating phase (block 20) can be selected such that the pasteurization temperature is achieved without verifying the food product temperature (block 25).

The illustrated embodiment of the inventive method further includes a drying phase (block 30). In at least some embodiments of the present technology, the drying phase starts after the pasteurizing temperature has been reached. It should be understood that some drying of the product may naturally occur during the heating phase (block 20) depending on the combination of temperature and relative humidity. For meat products such as jerky, the drying phase (block 30) may be terminated after the water activity decreases to about 0.85. In some embodiments of the present technology, the water activity of the food product can be verified (block 35) to assure that the required value has been reached before terminating the process. In other embodiments, a combination of drying time, temperature and relative humidity can be selected such that the target water activity is reached for a particular size and type of food product without verifying the water activity level. The food processing method 200 may finish (block 40) after the drying phase (block 30) and/or after verifying the water activity level.

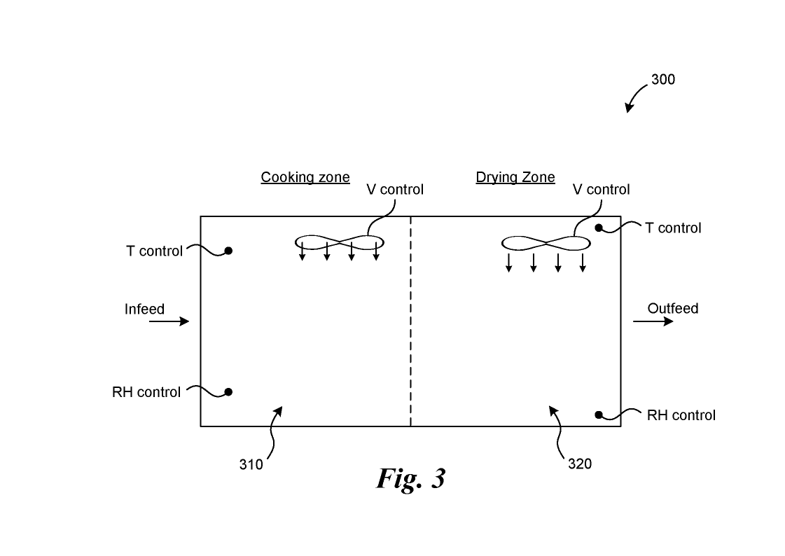

FIG. 3 is a schematic diagram illustrating a processing system 300 having two independently controlled zones including a heating zone 310 and a drying zone 320 in accordance with an embodiment of the technology. In the illustrated embodiment, the heating zone 310 and the drying zone 320 are separate chambers, but in other embodiments they may be the same chamber that operates using different sets of parameters during the heating and drying phases. In at least some embodiments, the food product may be seasoned before entering the processing equipment 300. The food product can be fed into an entrance of the heating zone 310 where the temperature, relative humidity and air speed can be controlled to provide a desired heating rate for the food product. In general, higher temperatures and air speeds decrease the duration of the heating phase. Additionally, lower relative humidity prevents water condensation at the surface of the product. The drying zone 320 can also have one or more controllable parameters such as temperature, relative humidity and/or air speed. In general, higher temperatures and air speeds reduce the duration of the drying phase, while higher relative humidities increase the duration of the drying phase. However, as explained below in relation to different embodiments of the inventive technology, a combination of temperature, relative humidity and/or air velocity can be used to optimize the drying phase. The food product can be removed from the system 300 at an exit of the drying zone 320.

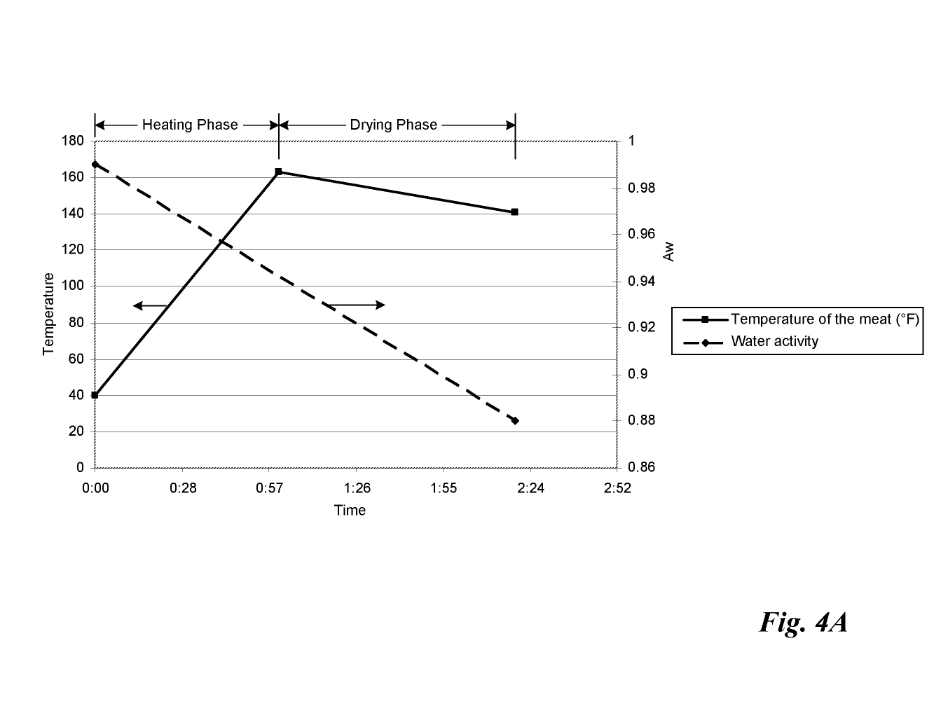

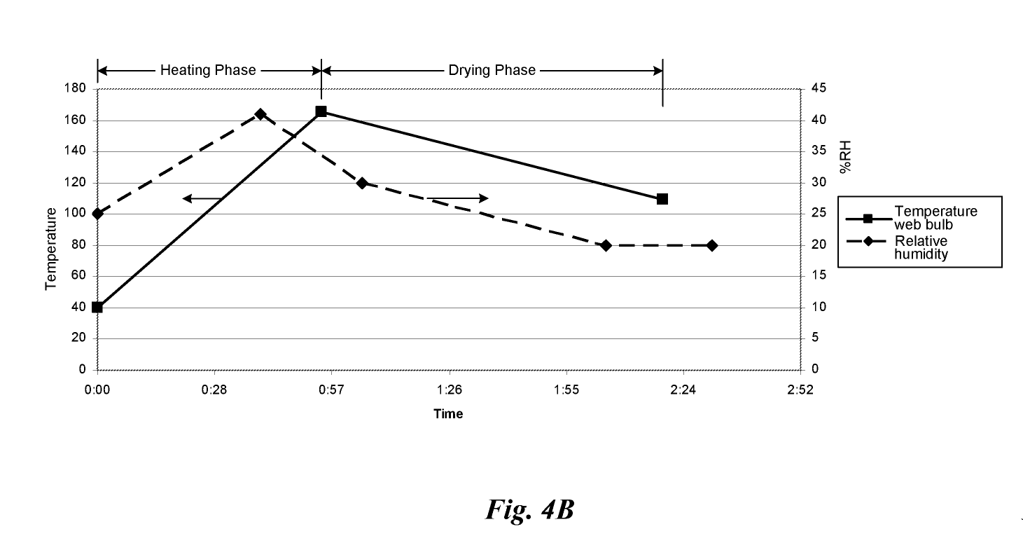

FIGS. 4A and 4B are charts illustrating an embodiment of operating the system 300. FIG. 4A shows the change of the temperature (solid line and the left vertical axis) and water content (dashed line and the right vertical axis) of the food product. FIG. 4B shows the parameters of the food processing equipment: the wet bulb temperature (solid line and the left vertical axis) and relative humidity (dashed line and the right vertical axis). The food product can be a meat product, for example flavored or un-flavored beef strips 3-4 mm thick. Other sizes and types of food product are also possible. In several embodiments, the processing equipment illustrated in FIG. 3 can be used. In other embodiments, a smoke house without the air velocity control can be used.

As illustrated in FIG. 4A, the food product can enter the drying zone 310 of the processing system 300 at a temperature of about 40° F. at the beginning of the heating phase. During the heating phase, the food product can be heated to about 165° F. within about 1 hour, i.e. increasing the temperature at about 2° F. per minute, thus achieving or exceeding a target pasteurization temperature of about 160° F. The food product can then be moved to the drying zone 320 for a drying phase during which the food product temperature can be kept at or below the pasteurization temperature while the water activity of the food product is further reduced to a target value of, for example, about 0.88 for beef jerky.

In the embodiment illustrated in FIG. 4A, the water activity of the food product is about 0.99 at the beginning of the heating phase, i.e. as the food product enters the heating zone 310. The water activity of the food product can be reduced from about 0.99 to about 0.95 during the heating phase, i.e., within approximately one hour during which the pasteurization temperature of the food product is reached. The water activity can be further reduced in the drying phase at a temperature lower than the pasteurization temperature of the food product. In the embodiment illustrated in FIG. 4A, the food product has the water activity of about 0.88 and the temperature of about 140° F. at the end of the end of the drying phase.

FIG. 4B illustrates the process equipment parameters corresponding to the food product parameters of FIG. 4A. The wet bulb temperature of the process equipment is shown on the left vertical axis, and the relative humidity of the process equipment is shown on the right vertical axis. A person of ordinary skill in the art would know that the dry bulb temperature of the food processing environment, which is higher than the wet bulb temperature, can be calculated from the combination of the wet bulb temperature and relative humidity. In the illustrated example, the wet bulb temperature is about 40° F. and the relative humidity is about 25% at the beginning of the heating phase. As the wet bulb temperature increases to about 165° F., the corresponding relative humidity increases to about 41%. The increase in the relative humidity coupled with the increased temperature can prevent or delay case hardening of the food product without causing the undesired water condensation on the surface of the food product. In the illustrated embodiments, the duration of the heating phase is about 1 hour, but other heating times are possible depending on the heating temperature, relative humidity and air velocity in the heating zone 310. During the drying phase, which in the illustrated embodiment takes about one hour and 20 minutes, the wet bulb temperature is reduced from about 165° F. to about 109° F. and the relative humidity in the processing equipment is reduced from below 40% to about 20%. This combination of the lower temperature and relative humidity inside the drying zone enables a more comfortable and less dangerous removal of the food product in comparison with, for example, processes that terminate at the pasteurization temperature. Furthermore, the duration of the process is reduced while the final water activity is closer to the desirable target value, i.e., the food product is not too dry.

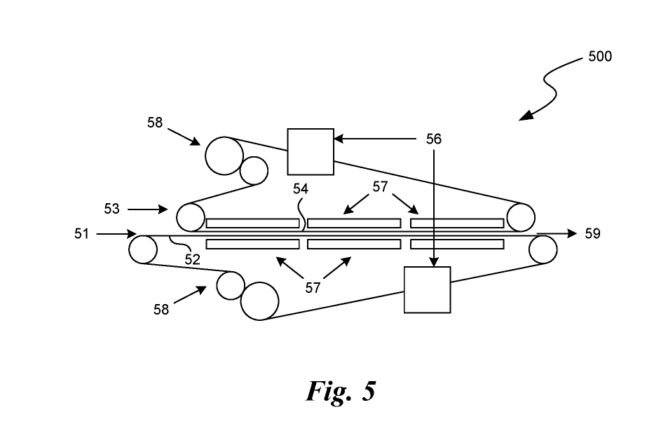

FIG. 5 is a schematic diagram illustrating a continuous belt grill 500 that can be used during the heating phase of the present technology. In at least some embodiments of the present technology, the heating and drying phases can be performed using different equipment. For example, it may be advantageous to shorten the heating phase by rapidly heating the food in equipment that can provide a high temperature and low relative humidity, followed by a drying phase in a separate piece of equipment having a lower temperature and higher relative humidity. Suitable processing equipment for a shortened heating phase is a continuous belt grill “Stein ProGrill 1000” manufactured by Frigoscandia, Sweden. With the illustrated equipment, a belt grill 500 can receive food products at an infeed 51 between a lower belt 52 and an upper belt 54 that carry the food product between heat platens 57 located below lower belt 52 and above the upper belt 54. In some embodiments of the continuous belt grill 500, the upper and lower heat platens 57 can have independently adjustable temperatures and distances from the belts 52 and/or 54. The temperature of the food product can be controlled by independently or collectively adjusting the temperatures of the heat platens 57, distances of the heat platens from the belts 52/54, and speed of the belts (controlled by the belt drives 58). The food product is removed from the continuous belt grill 500 at an outfeed 59. The belts 52 and 54 can be cleaned by one or more washing systems 56. In one example, the temperature of the heat platens can be 525° F. and the speed of the belt drives can be adjusted such that the food product stays between the heat platens from 30 seconds to about 4 minutes.

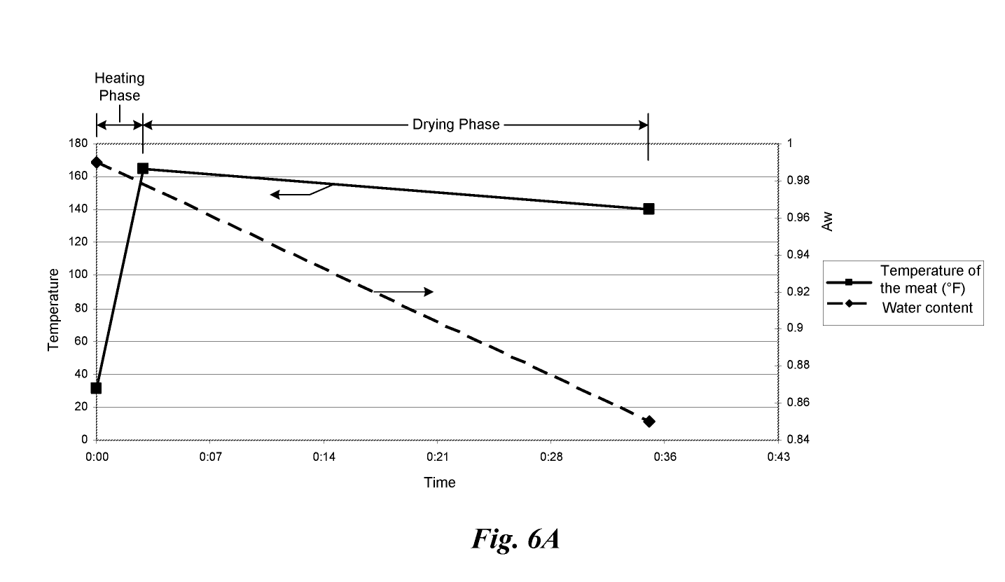

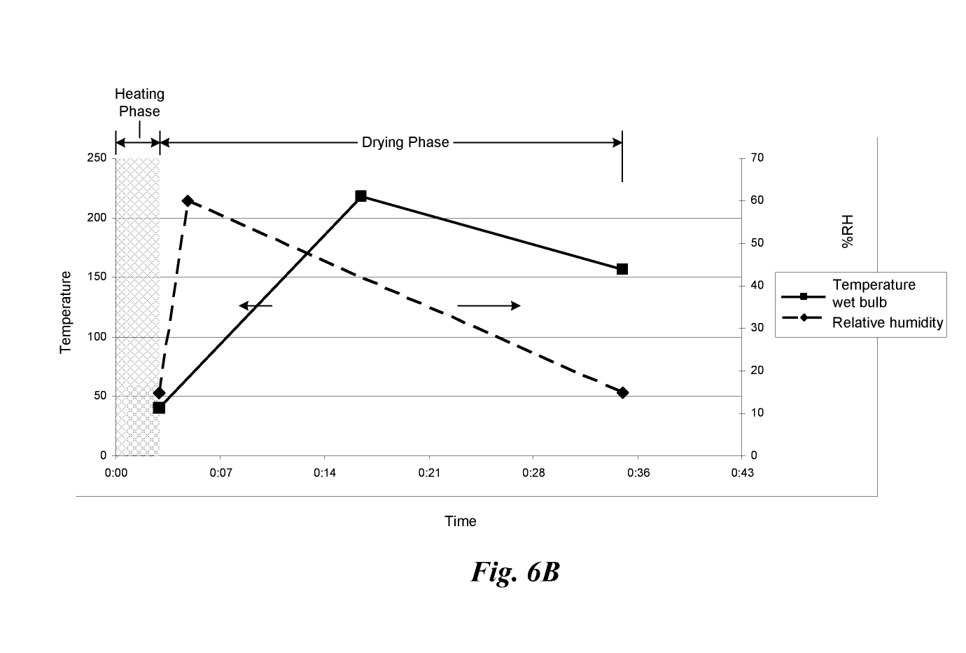

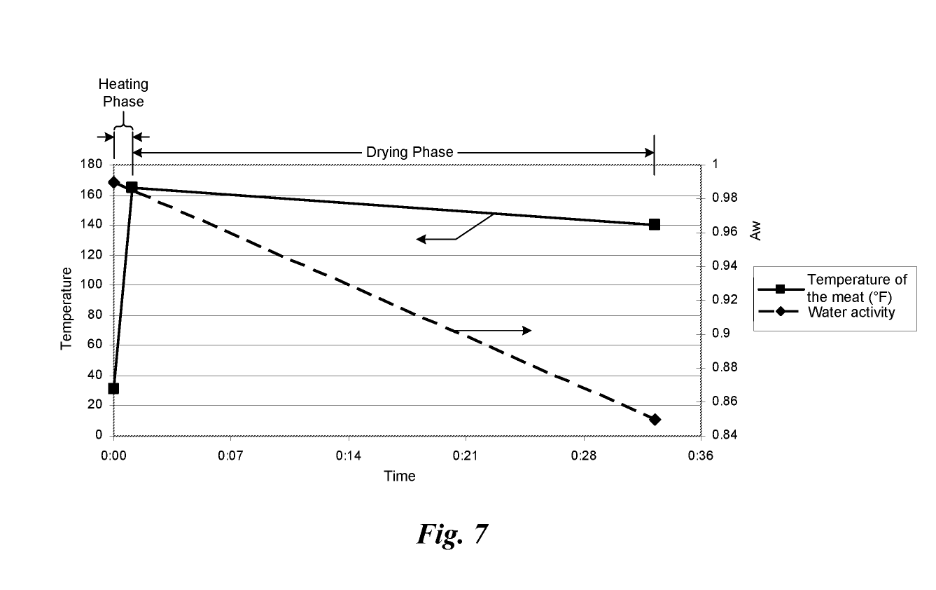

FIGS. 6A-7 illustrate several embodiments of the present technology using the rapid heating equipment described in conjunction with FIG. 5. As illustrated in FIG. 6A, the heating phase increases the temperature of the food product from about 30° F. to the pasteurizing temperature of about 160° F. in about 3 minutes. With this embodiment of the inventive technology, the food product can be kept in contact with the lower belt 52, but spaced apart from the upper belt 54. The temperature of the heat platens 57 can be kept at around 400° F. During the heating phase, the water activity of the food product can remain substantially unchanged (e.g., relatively constant) due to relatively short duration of the heating phase. This, in turn, makes the humidity control less important for the heating phase in this embodiment.

During the drying phase, the food products can be processed in conventional food processing equipment, such as the GCO oven made by FMC Food Technology of Sandusky, Ohio. During the drying phase, the temperature of the food product can be lowered below the pasteurization temperature while reducing the water activity of the food product to about 0.85. The combined processing time for the heating and drying phases of the food product can be about 37 minutes for some beef jerky food products.

FIG. 6B illustrates the food processing equipment parameters for the drying phase of the process described in conjunction with FIG. 6A. The wet bulb temperature in the oven is shown on the left vertical axis, while the relative humidity is shown on the right vertical axis. The relative humidity in the oven can be raised to about 60% within about 3 minutes to prevent case hardening of the food product as the temperature of the oven is raised to a wet bulb temperature of about 218° F. within about 17 minutes. Due to the higher temperature in the oven, the duration of the drying phase is further reduced in comparison to the duration of the drying phase of the embodiments described in conjunction with FIGS. 4A-4B. Under the wet bulb temperature and the relative humidity conditions illustrated in FIG. 6B, the water activity of the food product can reach the target value of about 0.85 in about 35 minutes, thus further reducing the combined duration of the heating and drying phases of the inventive method.

FIG. 7 illustrates another embodiment of the present technology which can also use the rapid heating equipment described in conjunction with FIG. 5. In the embodiment illustrated in FIG. 7, the heating phase can be further reduced to about 1 minute by contacting the food product with the lower belt 52 and upper belt 54, while the temperature of the heat platens 57 is about 400° F. By reducing the heating time to about 1 minute, the throughput of the rapid heating equipment is increased. Since the water activity of the food product does not significantly change during such a short heating phase, the water activity of the food product is reduced to about 0.85 during the drying phase, which can be similar to the drying phase described in conjunction with FIG. 6B.

The above Detailed Description of examples of the technology is not intended to be exhaustive or to limit the technology to the precise form disclosed above. For example, the heating phase can have a nonlinear temperature rise for faster heating without burning the skin of the food. Furthermore, in some embodiments a superheated steam can be used during the drying phase to shorten the drying process while reducing the risk of case hardening of the surface of the product. In some other embodiments, several pieces of processing equipment can be used for a given phase of the food product processing like, for example, the drying phase. Additionally, one or more transitional or intermediate phases can be added to the heating and drying phases and/or the heating and drying phases can have several sub-phases to shorten the time for reaching the pasteurization temperature and target water activity in the food product. A person of ordinary skill in the art will understand that many variations of the temperature, water activity and relative humidity can be used within the scope of the present inventive technology. Furthermore, some well-known structures or functions may not be shown or described in detail below, in order to emphasize the relevant parts of the invention description of the present technology. The terminology used below is to be interpreted in its broadest reasonable manner, even though it is being used in conjunction with a detailed description of certain specific examples of the present technology. Therefore, the actual scope of the invention encompasses not only the disclosed examples, but also all equivalent ways of practicing or implementing the invention under the claims.

1. A method for processing a meat product, the method comprising:
heating the meat product to at least a pasteurizing temperature of the meat product in a first oven and
after heating the meat in the first oven, drying the meat product in a second oven, wherein drying the meat in the second oven includes reducing a water activity of the meat product form a first water activity of at least 0.92 to a second water activity of at most 0.85.

2. (canceled)

3. The method of claim 1 wherein heating the meat product in the first oven includes heating the meat product in the first oven while controlling a relative humidity in the first oven.

4. The method of claim 1 wherein drying the meat product in the second oven includes drying the meat product in the second oven while controlling a relative humidity in the second oven.

5-10. (canceled)

11. The method of claim 1 wherein:
heating of the meat product in the first oven includes raising a temperature of the meat product to 165° F. within 1 minute; and
the meat product in second oven includes lowering the temperature of the meat product from 165° F. to 140° F. within 30 minutes.

12-14. (canceled)

15. The method of claim 1 wherein:
heating the meat product in the first oven includes heating the meat product in the first oven while the first oven is at a heating humidity; and
drying the meat product in the second oven includes drying the meat product in the second oven while a humidity in the second oven is lower than the heat humidity.

16-17. (canceled)

18. The method of claim 1, further comprising verifying a temperature of the meat product.

19. The method of claim 18 wherein verifying the temperature of the meat product includes verifying the temperature of the meat product after heating the meat product in the first oven.

20. The method of claim 1, further comprising verifying the water activity of the meat product.

21. The method of claim 20 wherein verifying the water activity of the meat product includes verifying the water activity of the meat product after drying the meat product in the second oven.

22. A method for processing a meat product, the method comprising:
contacting the meat product and a grill;
conductively heating the meat product to at least a pasteurizing temperature of the meat product via the grill; and
after conductively heating the meat product, drying the meat product in an oven, wherein drying the meat product includes reducing a water activity of the meat product from a first water activity of at least 0.92 to a second water activity of at most 0.85.

23. The method of claim 22 wherein conductively heating the meat product includes conductively heating the meat product via a heated continuous belt of the grill.

24. The method of claim 22 wherein:
contacting the meat product and the grill includes simultaneously contacting a first side of the meat product with a first heated continuous belt of the grill and contacting an opposite second side of the meat product with a second heated continuous belt of the grill; and
conductively heating the meat product includes conductively heating the meat product via the first and second belts.

25. The method of claim 22 wherein:
conductively heating the meat product includes raising a temperature of the meat product to 165° F. within 1 minute; and
drying the meat product includes lowering the temperature of the meat product from 165° F. to 140° F. within 30 minutes.

26. The method of claim 22, further comprising verifying a temperature of the meat product.

27. The method of claim 26 wherein verifying the temperature of the meat product includes verifying the temperature of the meat product after conductively heating the meat product.

28. The method of claim 22, further comprising verifying the water activity of the meat product.

29. The method of claim 28 wherein verifying the water activity of the meat product includes verifying the water activity of the meat product after drying the meat product.
